(19) United States
(12) Patent Application Publication
(10) Pub. No.: US 2011/0140004 A1
(43) Pub. Date: Jun. 16, 2011

(54) GLASS ARTICLE WITH IDENTIFICATION MEANS AND METHOD FOR IDENTIFYING A GLASS ARTICLE

(75) Inventors: Daniel Decroupet, Jumet (BE); Fabrice Sinapi, Jumet (BE); Pavel Cumpelik, Jumet (BE)

(73) Assignee: AGC Glass Europe, Bruxelles (Watermael-Boitsfort) (BE)

(21) Appl. No.: 13/002,804

(22) PCT Filed: Jul. 22, 2008
(86) PCT No.: PCT/EP2008/059586

§ 371 Date: Jan. 6, 2011

(51) Int. Cl. G01J 1/58; B44F 1/10; B01J 21/08

(52) U.S. Cl. 250/459.1; 428/29; 502/232

(57) ABSTRACT

A glass article comprising identification means and a method for detecting the presence of the said identification means are disclosed. The glass article comprises at least one glass sheet which is covered by a layer comprising dispersed and invisible identification means. The identification means according to the invention allows identification of the presence of an intrinsic characteristic of said glass article which is invisible to the naked eye or difficult to detect.

This invention relates to a glass article comprising identification means. In particular, the invention relates to a glass article comprising means for the identification of the presence of an intrinsic characteristic of said glass article which is invisible to the naked eye or difficult to detect. The invention also relates to a method for indirectly detecting the presence in a glass article of an intrinsic characteristic which is invisible to the naked eye or difficult to detect.

In particular, flat glass articles often display characteristics which are invisible to the naked eye or difficult to detect like some transparent coatings or surface treatments. A good illustrative example of an invisible characteristic of a glass article is the antimicrobial property. In such a glass article, the antimicrobial character is indistinguishable to the naked eye in comparison with a similar glass article but which does not display an antimicrobial activity.

It is of high concern for many reasons to be able to identify the presence of invisible intrinsic characteristics of glass articles by specific and indirect identification means. The most important reason is that identification means in glass products could help to distinguish between genuine or authorized articles and counterfeit articles, for example, within the framework of litigation.

Therefore, there is a need to provide specific and reliable identification means and identification method of a glass article in order to indirectly detect the presence of one or more invisible characteristic(s) in the said glass article, and/or in order to authenticate a glass article. Moreover, identification means which are invisible and which provide rapid, in situ and non destructive identification are preferable.

An identification method of an article using spectral codes is known from U.S. Pat. No. 7,038,766 B2. In this document, an article for which identification is desired is tagged by the application of a mark. The mark can be applied to, affixed to, mixed into (in the case of a powder), or connected to the article to be further identified. The mark includes identification means which may be energy-responsive elements and/or coded microparticles including a sequence of visually distinguishable dyed and/or pigmented layers. The energy-responsive elements act as identification means as, upon energy stimulation, they yield a spectral signature that characterizes the elements' response to stimulation. The identification is carried out by scanning the mark and detecting the spectral signature using a reading device which compares the read signature and a predefined signature.

This existing solution for identification of an article however displays several main drawbacks, in particular while considering articles made of flat glass.

The particular case of powder article is not concerned in the following remarks. First, as the mark is applied directly to the surface of an article or connected to it, it represents an extrinsic element of the article. For this reason, the identification means could be detectable by the naked eye and therefore detract the aesthetic and/or function of the article itself, especially in the case of a transparent flat glass articles. Moreover, for the same reason, the mark could in some cases be easily removed from the article by a violator, for example, without detracting the integrity of the article itself. Secondly, the mark is affixed to a localized and defined place on the surface of the article. If the article has a large surface, like flat glass articles, the identification requires the localization of the mark which could represent a tedious job when the mark is not highly invisible. Moreover, if the flat glass article is mounted in a window frame, the mark may be hidden by the said frame and impossible to reach for a future identification without dismantling the window.

The present invention allows overcoming these drawbacks by providing a glass article comprising specific identification means
(i) which are invisible to the naked eye,
(ii) which are dispersed on the whole surface of the glass article,
(iii) which belongs intrinsically to the article without detracting its aesthetic and/or function and,
(iv) which is also impossible to remove from the said article.

The invention also provides a method of identification or detection, using the specific identification means cited above, which is rapid, non destructive and which could be used in situ. From a practical point of view, the invention provides a way to interrogate the specific identification means in order to confirm or not the presence in a glass article of a intrinsic characteristic which is related to the specific identification means, and/or in order to authenticate a glass article. For example, the method of the invention allows identifying the presence of the invisible antimicrobial property in a glass article along its whole life by the incorporation, during the production of the said article, of identification means, specific to this antimicrobial property and allowing a future identification if required. The identification method of the invention may further be implemented during the whole life of the glass article once produced. For example, the identification method may be used during storage, transportation, transformation by clients of the glass article or even, once fixedly installed in buildings, automobiles, . . . .

The present invention provides a glass article as defined in Claim 1.

Dependent claims define further preferred and/or alternative embodiments of the invention.

The present invention shall be described in more detail below, in a non-restrictive manner, with references to the attached drawings (not at scale).

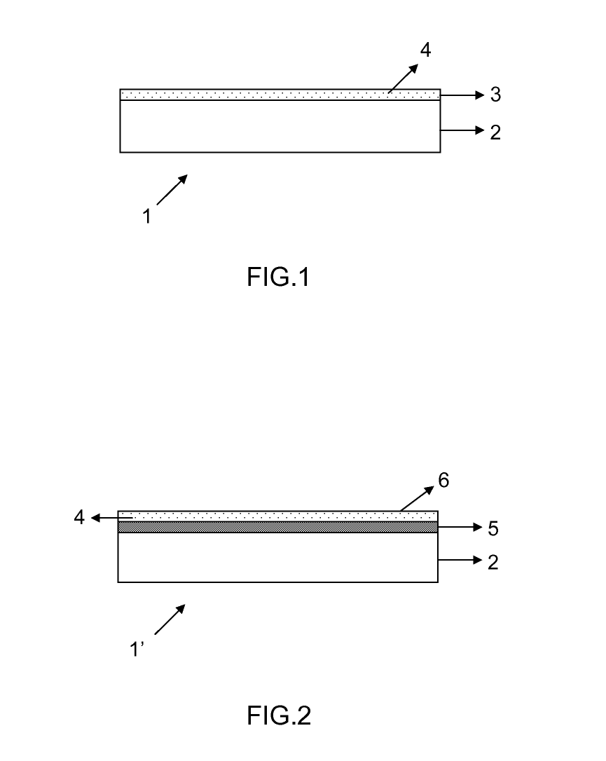

FIG. 1 is an enlarged, cross-sectional view of a glass article covered by a layer comprising dispersed and invisible identification means according to the invention.

FIG. 2 is a variation of the embodiment of FIG. 1.

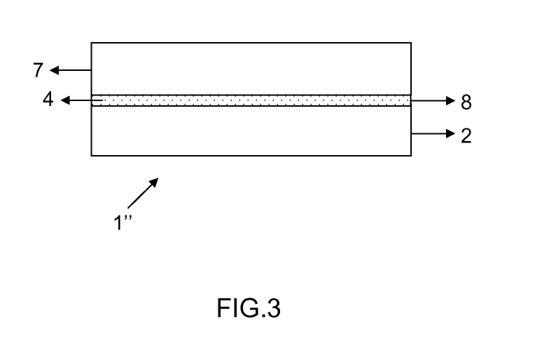

FIG. 3 is another variation of the embodiment of FIG. 1.

As illustrated in FIG. 1, the glass article (1) according to the invention comprises at least one glass sheet (2) covered on one of its face by a layer (3) comprising dispersed and invisible identification means (4).

Preferably, the at least one glass sheet (2) is made of soda-lime glass. By soda-lime glass, it is meant a glass having the following composition, expressed in percentages by weight:

| | |
|---|---|
| SiO₂ | 60 to 75%, |
| Na₂O | 10 to 20%, |
| CaO | 0 to 16%, |
| K₂O | 0 to 10%, |
| MgO | 0 to 10%, |
| Al₂O₃ | 0 to 5%, |
| BaO | 0 to 2%, |

with both further conditions:

alkaline-earth oxides (BaO+CaO+MgO) totalising from 10 to 20%,

alkaline oxides (Na₂O+K₂O) totalising from 10 to 20%.

Minor additives may as well be present in very small proportions in the glass composition, like colourants (Fe₂O₃, FeO, CoO, Nd₂O₃, . . . ), redox components (NaNO₃, Na₂SO₄, coke, . . . ) and the like.

The glass sheet (2) according to the invention may be a float glass and it may have a thickness of from 0.5 to 15 mm. The glass sheet (2) may also be made of clear, extra-clear, coloured and/or etched glass. The glass sheet (2) may also be thermally toughened.

The glass article (1) according to the invention may be implemented in a multiple glazing, formed by assembling said glass article with an additional glass sheet in spaced relation by means of intervening spacer strips glued or soldered to marginal face portions of the sheets. In that case, the layer according to the invention may be internal or external to the assembly.

The glass article (1) according to the invention may also be implemented in a laminated assembly. In that case, the layer according to the invention may be internal or external to the assembly.

According to the invention, the at least one glass sheet (2) of the article (1) is covered on one of its faces by a layer (3). The said layer may be in direct contact with the glass sheet as shown in the embodiment of FIG. 1. Alternatively, one or several coating(s) may be interposed between the glass sheet and the layer.

According to the invention, the layer (3) preferably covers the whole surface of the sheet face as shown in the embodiment of FIG. 1.

The layer (3) according to the present invention comprises dispersed and invisible identification means (4). By identification means, it is meant any means allowing the further identification of the presence of one or more intrinsic characteristic(s) of the said glass article.

According to the invention, the identification means (4) are invisible to the naked eye.

According to the invention, the identifications means (4) are dispersed in the layer (3). In a preferred manner, they are homogeneously dispersed in the layer (3).

Advantageously, the identification means (4) are energy-responsive particles. Energy-responsive particles according to this invention are particles which, upon energy excitation or stimulation, yield a specific energy response that characterizes the response of the particles to the stimulation.

In a particular embodiment of the invention, the layer comprises between 0.001 and 15% in weight of the energy-responsive particles. Preferably, the layer comprises between 0.025 and 5% in weight of the energy-responsive particles.

In another particular embodiment, energy-responsive particles have a size of from 0.1 μm to 500 μm. Preferably, energy-responsive particles have a size of from 0.2 μm to 100 μm.

The energy stimulation of the energy-responsive particles may be an electromagnetic radiation, an electric current, heat, cold, . . . .

The response of the energy-responsive particles depends upon the stimulation provided as well as the material of the particles themselves. The energy response of the particles excited by energy stimulation may be an electromagnetic radiation.

When a material is excited and then re-emits an electromagnetic radiation, the phenomenon occurring is called luminescence. This luminescence is described as an excitation to a higher energy state and then a return to a lower energy state accompanied by the emission of an electromagnetic radiation (or photons). When the excitation occurs from an electromagnetic radiation (or photons), the phenomenon is called photoluminescence. In this particular case, the material is excited by a specific wavelength and re-emits a different (but equally specific) wavelength or range of wavelengths (spectrum). Main forms of photoluminescence are fluorescence and phosphorescence.

According to an embodiment, energy-responsive particles comprise at least one luminophore. It is meant by luminophore a substance which exhibits the phenomenon of luminescence.

The luminophore preferably consists of a host matrix doped by at least one luminescent element. An activator may sometimes be added in the matrix in order to prolong the emission time.

Preferably, the host matrix is selected from oxides, oxysulfides, selenides, sulfides, phosphates, halides and their mixtures. Examples of host matrixes for luminophores are yttrium oxide, yttrium oxysulfide, yttrium silicate, zinc sulphide, cadmium sulphide, lanthanum phosphate, silver halide and yttrium niobate.

Preferably, the at least one luminescent element is selected from Y, Nb, Ce, Pr, Nd, Pm, Sm, Eu, Tb, Dy, Ho, Er, Tm and Yb.

According to the invention, the layer comprising the identification means and covering the at least one glass sheet of the glass article is additionally a functional layer.

The functional layer which has at least one function selected amongst coloration, antireflection, protective, adhesive, hydrophobic, hydrophilic, anti-fogging, electrochromic, photochromic, photocatalytic, anti-fire, antimicrobial, anti-scratch, anti-wear, anti-corrosion, anti-impact, anti-UV, solar control, low-emissivity, UV-cut or IR-cut function.

By a functional layer with an antireflection function, it is intended a layer which enables to reduce the light reflection of the glass article. An antireflection layer therefore increases the light transmitted by the glass article.

By a functional layer with a protective function, it is intended a layer which provide chemical and/or mechanical protection to the glass article itself or to an additional coating present in the glass article. An example of chemical protection is protection against corrosion. An example of mechanical protection is protection against abrasion or scratches.

By a functional layer with an adhesive function, it is intended a layer which bonds two glass sheet together while further enhancing the performance of the glass article (safety, protection against bullets or explosions, sound insulation, for example).

By a functional layer with an electrochromic function, it is intended a layer which reversibly changes colour when en electrical current is applied. In the glass article, the layer preferably changes between a coloured form and a transparent form.

By a functional layer with a photochromic function, it is intended a layer which reversibly changes colour upon exposure to a specific electromagnetic radiation.

By a functional layer with an antimicrobial function, it is intended a layer which enables to kill or inhibit the growth of microbes, such as bacteria, fungi, or viruses, which has entered in contact with the said layer.

By a functional layer with an anti-corrosion function, it is intended a layer which enables to reduce or suppress the corrosion phenomenon of glass. Soda-lime glass may actually undergo corrosion by depletion of alkaline ions under unfavourable environmental conditions, in particular in aqueous medium with basic pH.

By a functional layer with an anti-UV function, it is intended a layer which enables to reduce the transmission of ultraviolet radiation through the glass article. This is of particular interest in order to limit the discolouration of objects exposed behind the glass article to solar radiation. By ultraviolet radiation, it is meant radiation with wavelengths of from 280 to 380 nm.

By a functional layer with a solar control function, it is intended a layer which limiting passage of the incident solar energy radiation through the glass article to avoid overheating the interior space delimiting by the said glass article. By solar energy radiation, it is meant radiation with wavelengths of from 300 to 2500 nm.

By a functional layer with a low-emissivity function, it is intended a layer which limits heat loss from the interior space through the glass article. This heat loss occurs via (i) absorption by the glass article of longwave infrared radiation (over 2500 nm) radiated by objects in the interior space, (ii) heating-up of the said article following by (iii) emission of heat to the exterior.

By a functional layer with a UV-cut or IR-cut function, it is intended a layer which blocks the transmission through the glass article of ultraviolet or infrared radiations, respectively, by reflection or absorption phenomena. In particular, this layer enables cut-off at a specific wavelength and blocks all wavelengths above or below.

According to a particular embodiment of the invention, the functional layer is deposited by a sol-gel process.

In the typical sol-gel process, the precursors used are usually inorganic metal salts or metal organic compounds such as metal alkoxides. A solution of precursors is first subjected to a series of hydrolysis and polycondensation reactions to form a colloidal suspension, or a “sol”. The sol evolves then towards the formation of an inorganic continuous network containing a liquid phase (“gel”). Formation of a metal M oxide involves connecting the metal centers with oxo (M-O-M) or hydroxo (M-OH-M) bridges, therefore generating metal-oxo or metal-hydroxo polymers in solution. A drying process serves to remove the liquid phase from the gel thus forming a ceramic material. A thermal treatment (firing) may be further performed in order to enhance mechanical properties of the ceramic material. Particular processing of the “sol”, for example by dip-coating or spin-coating, enables to make ceramic materials in the form of a layer on a substrate.

According to another particular embodiment of the invention, the functional layer may be a coloured lacquer layer.

By lacquer, it is intended paints or enamels. Paints that are suitable may have various organic base resins, like polyurethane, silicone, alkyd, polyester, phenol, amino, epoxy, acrylic, methacrylic, acryl-styrene and acrylamide resins in association with organic and/or mineral pigments. Paints of the cross-linking type are preferred. Such paints have the advantage to form hardened layers on the glass surface after drying. Suitable enamels according to this embodiment comprise mineral pigments associated with a more fusible glass composition than the glass sheet and a medium. The medium may be composed of various organic resins, like polyurethane, silicone, alkyd, polyester, phenol, amino, epoxy, acrylic, methacrylic, acryl-styrene and acrylamide resins and preferably contains UV- or IR-crosslinkable elements.

Preferably, the lacquer layer is in direct contact with the glass sheet. Alternatively, an adhesion promoter may be present between the glass sheet and the lacquer layer to improve the adhesion of the layer to the glass sheet.

The coloured lacquer layer may be of any color, including black and white.

The lacquer layer may be applied by any method known in the art, for example the processes of roller coating or curtain coating, the spray process or flow process.

According to another alternative embodiment illustrated in FIG. 2, the glass article (1′) further comprises a reflective metallic coating (5) deposited on the at least one glass sheet (2) and the layer comprising the identification means (4) is a protective layer (6) applied on said metallic coating (5).

The glass article according to this particular embodiment may be used as a reflective mirror (1′) and therefore it has various applications, for example: domestic mirrors used for example in furniture, wardrobes or bathroom; mirrors in make-up boxes or kits; mirrors used in the automotive industry, like rear-view mirrors for cars.

Commonly used metal for the reflective coating (5) is metallic silver.

Preferably, the protective layer (6) is a paint layer. It serves in part to prevent abrasion of the reflective metallic coating but more importantly provides the metal with resistance to corrosion. If such protection is not provided, the reflective metallic coating tends to undergo oxidation or attack by atmospheric pollutants, resulting in tarnishing and discolouration and thus a reduction of the specular reflective properties of the article.

Preferably, paints are coloured paints. Suitable coloured paints comprise pigments and a binder. Preferred binders include acrylic, alkyd, epoxy, cellulosic, phenolic and polyester resins. Suitable paints may comprise lead. Alternatively, suitable paint may be lead-free or substantially lead-free.

According to this particular embodiment, a plurality of protective paint layers may be deposited on the reflective metallic coating. Preferably, only one paint layer comprises identification means.

According to this embodiment, the paint layer is applied on a liquid form on the reflective metal coating by means of a curtain coating apparatus. The paint layer is then dried or cured, for example in a tunnel oven.

According to another alternative embodiment illustrated in FIG. 3, the glass article (1″) further comprises at least one additional glass sheet (7) which covers the layer comprising the identification means. In this embodiment, the layer is an adhesive layer (8) bonding the two glass sheets (2,7) and therefore forming a laminated assembly (1″).

According to this embodiment, the adhesive layer (8) is preferably an organic resin layer. The organic resin layer is preferably of thermoplastic type. It may consist of materials such as polyvinyl acetals, especially polyvinyl butyral, which are widely used in laminated safety glazing, but also polyvinyl chlorides, polyolefins, etc.

Preferably, the organic resin layer has a thickness of at most 1 mm. Most preferably, the thickness of the organic resin layer is less than or equal to 0.38 mm. Moreover, the organic resin layer may be of acoustic type.

This embodiment may be implemented using a plurality of superposed adhesive layers between the two glass sheets. Preferably, only one adhesive layer comprises identification means.

In a particular embodiment, a plurality of glass sheets may be implemented in the laminated assembly according to the invention. In that case, at least one adhesive layer is interposed between each pairs of glass sheets. Preferably, only one adhesive layer comprises identification means. Alternatively, more than one adhesive layer comprise identification means.

In another particular embodiment, the laminated assembly according to the invention may if desired comprise at least two glass sheets of different thicknesses.

The methods to produce conventional laminated glass assemblies as indicated above may differ appreciably depending in particular on the dimensions of the glass sheets, but also on the nature of the interlayer. However, all the techniques comprise the use of temperature and pressure. These two conditions have the effect of making the organic resin interlayer more malleable and of imposing contact between this interlayer and the rigid glass sheets in order to obtain good adhesion. The pressure exerted during assembly may result from applying a vacuum to the assembly, this having the additional function of removing the air present between the sheets jointed together, or the mechanical compression of the constituent sheets, which compression may be combined with a relatively high vacuum. For the very large volumes, the only practical possibility consists in subjecting the sheets to one or more calendering operations, preferably at a temperature favouring modest softening of the interlayer.

The invention also provides a method of detecting the presence of energy-responsive particles in a glass article according to the invention.

The terms which will be used below have, otherwise specified, the same specifications as already mentioned in the above description.

The method of detecting the presence of energy-responsive particles in a glass article according to the invention includes the step of:
a) subjecting the glass article to an energy stimulation
b) checking whether the glass article includes energy-responsive particles by detecting an energy response from the energy-responsive particles.

In this method, the energy stimulation and/or energy response may pass through the glass article or not.

As already specified, the energy stimulation of the energy-responsive particles may be an electromagnetic radiation, an electric current, heat, cold, . . . .

In a preferred embodiment, the energy stimulation is an electromagnetic radiation. The electromagnetic radiation according to this embodiment may be in the ultraviolet, visible, infrared, microwaves or radio-waves domain.

When the energy stimulation is an electromagnetic radiation, the stimulation may be implemented by a punctual excitation source. The excitation source is preferably handheld for in situ identification. For example, the stimulation may be provided by a laser of a specific wavelength as excitation source.

In another preferred embodiment, the energy response of the particles is an electromagnetic radiation. The electromagnetic radiation according to this embodiment may be in the ultraviolet, visible, infrared, microwaves or radio-waves domain. Preferably, the electromagnetic radiation is a visible radiation with a range of wavelengths between 400 and 700 nm. Most preferably, the electromagnetic radiation is a visible radiation with a range of wavelengths between 450 and 550 nm.

The delay between excitation of the energy-responsive particles and their energy response is variable. This delay may be of few nanoseconds to few minutes and even to few hours. Preferably, the delay of response according to the invention may be of few nanoseconds to few seconds.

In a preferred embodiment, the excitation of the energy-responsive particles is reversible. In other words, the energy-responsive particles stop emitting immediately or within a short period of time when the excitation source is shut off and then, if the excitation source is turned on again, they restart to emit.

The method according to the invention includes the step of detecting an energy response. The detection may be implemented by a suitable detector. The nature of the detector obviously depends on the nature of the energy response expected. For example, when the energy response is visible light, the detector may simply be the eye. In that case, the detection may be implemented in a dark room when the visible light response displays a low intensity.

Preferably, the detector is also handheld for in situ identification. The detector may also include the excitation source to provide the stimulation required to generate the energy response. The detector may also be able to detect a wide range of wavelengths to accommodate a wide range of types of energy-responsive particles.

The invention will now be illustrated below by examples aiming at better describing the invention, without by no means trying to limit its scope.

### EXAMPLE 1

A glass article according to the invention has been prepared as follows:

Firstly, energy-responsive particles have been dispersed in a white coloured lacquer in a tank of a mixer with rollers. The mixture has been agitated during 10 minutes with 120 rotations/minutes. The white coloured lacquer used was a paint comprising an acrylic resin and pigments.

In this example, the energy-responsive particles which have been used comprise essentially yttrium oxide and yttrium oxysulfides as host matrix and ytterbium and erbium as lanthanide elements. Their size ranges from 1 to 5 μm. The amounts (in weight percentage) of energy-responsive particles dispersed in the white lacquer were: 0.0025, 0.0125, 0.025, 0.05, 0.25 and 1 wt %. When excited with an infrared light source, these energy-responsive particles give a visible green light as response.

The mixture of the paint and the energy-responsive particles obtained has then been deposited on a clear glass sheet. The glass sheet used had a thickness of 4 mm, a length of 40 cm and a width of 20 cm. The deposition has been carried out by means of a coater and the wet layer obtained on the glass sheet had a thickness of approximately 50 μm. Finally, the layered glass sheet has been dried at 66° C. during 10 minutes.

Tests have then been carried out on the glass articles with different amounts of energy-responsive particles to detect the presence of these particles. A laser pen with a wavelength in the near-infrared domain (300 mW) has been pointed out anywhere on the paint layer or on the face of the glass sheet not covered by the layer. A green light response has been observed under normal lighting for the glass articles prepared with 0.025, 0.05, 0.25 and 1 wt % of energy-responsive particles. A green light response has been observed in a dark room for the glass articles prepared with 0.0025 and 0.0125 wt % of energy-responsive particles.

### EXAMPLE 2

Another glass article according to the invention has been prepared according to the same procedure and specifications as used in example 1, except that, in this example, (i) the lacquer is a black coloured paint comprising an acrylic resin and pigments and (ii) the amounts (in weight percentage) of energy-responsive particles dispersed in the lacquer were 1 and 10 and 15 wt %.

Detection tests have then been carried out on the glass articles with different amounts of energy-responsive particles. A laser pen with a wavelength in the near-infrared domain (300 mW) has been pointed out anywhere on the paint layer or on the face of the glass sheet not covered by the layer. No response has been observed for the glass article prepared with 1 wt % of energy-responsive particles. A green light response has been observed under normal lighting for the glass articles prepared with 10 and 15 wt % of energy-responsive particles.

### EXAMPLE 3

Another glass article according to the invention has been prepared as follows:

Firstly, energy-responsive particles have been dispersed in a green colored paint by the same method as described in example 1. The coloured paint used comprised an alkyd resin and melamine formaldehyde as binders as well as pigments.

In this example, the energy-responsive particles which have been used comprise essentially a mixture of yttrium oxide and yttrium oxysulfide as host matrix and ytterbium and erbium as lanthanide elements. Their size ranges from 1 to 5 μm and the amounts (in weight percentage) of energy-responsive particles dispersed in the lacquer were: 0.0025, 0.0125, 0.025, 0.05, 0.25 and 1 wt %.

A glass sheet with a thickness of 2 mm, a length of 40 cm and a width of 20 cm has first been polished, rinsed and then sensitised by means of a tin chloride solution, and finally rinsed. An acidic aqueous solution of PdCl₂ has then been sprayed onto the glass sheet. The glass sheet has then been passed to a rinsing station where demineralised water has been sprayed, and then to the silvering station where a traditional silvering solution, comprising a silver salt and a reducing agent, has been sprayed to form a coating containing approximately 800-850 mg/m2 of silver. The glass sheet has then been rinsed by spraying with water and, directly after the rinsing of the silver coating, a freshly formed acidified solution of tin chloride has been sprayed onto the silvered glass sheet.

After rinsing and drying, the silver coating has been covered by a layer of the mixture of the paint and the energy-responsive particles prepared as described above. The thickness of the wet paint layer was approximately 100 μm. Finally, the glass sheet has been dried at 66° C. during 20 minutes.

Detection tests have then been carried out on the glass articles with different amounts of energy-responsive particles. A laser pen with a wavelength in the near-infrared domain (300 mW) has been pointed out anywhere on the paint layer. A green light response has been observed trough the sheet under normal lighting for the glass articles prepared with 0.025, 0.05, 0.25 and 1 wt % of energy-responsive particles. A green light response has been observed in a dark room for the glass articles prepared with 0.0025 and 0.0125 wt % of energy-responsive particles.

1. A glass article comprising:
a glass sheet; and
a layer comprising a plurality of dispersed and invisible identification means,
wherein the glass sheet is covered by the layer, and wherein
the layer is additionally a functional layer which has at least one function selected amongst coloration, antireflection, protective, adhesive, hydrophobic, hydrophilic, anti-fogging, electrochromic, photochromic, photocatalytic, anti-fire, antimicrobial, anti-scratch, anti-wear, anti-corrosion, anti-impact, anti-UV, solar control, low-emissivity, UV-cut or IR-cut function.

2. The glass article according to claim 1, wherein the layer is deposited by a sol-gel process.

3. The glass article according to claim 1, wherein the layer is a coloured lacquer layer.

4. The glass article according to claim 1, further comprising a reflective metallic coating deposited on the glass sheet and wherein the layer is a protective layer applied on said metallic coating.

5. The glass article according to claim 1, further comprising at least one additional glass sheet and an adhesive organic resin layer,
wherein the at least one additional glass sheet covers the adhesive organic resin layer forming a laminated assembly.

6. The glass article according to claim 1, wherein the identification means are energy-responsive particles.

7. The glass article according to claim 6, wherein the layer comprises between 0.001 and 15% in weight of the energy-responsive particles.

8. The glass article according to claim 6, wherein the energy-responsive particles have a size of from 0.1 μm to 500 μm.

9. The glass article according to claim 6, wherein the energy-responsive particles comprise at least one luminophore.

10. The glass article according to claim 9, wherein the luminophore consists of a host matrix doped by at least one luminescent element.

11. The glass article according to claim 10, wherein the host matrix is selected from the group consisting of oxides, oxysulfides, selenides, sulfides, phosphates, halides and mixtures thereof.

12. The glass article according to claim 10, wherein the at least one luminescent element is selected from the group consisting of Y, Nb, Ce, Pr, Nd, Pm, Sm, Eu, Tb, Dy, Ho, Er, Tm and Yb.

13. A method of detecting the presence of energy-responsive particles in a glass article according to claim 6, said method comprising:
subjecting the glass article to an energy stimulation; and
detecting an energy response from the energy-responsive particles.

14. The method according to claim 13, wherein the energy stimulation is an electromagnetic radiation.

15. The method according to claim 13, wherein the energy response is an electromagnetic radiation and preferably, a visible radiation with a range of wavelengths between 400 and 700 nm.
